(19) United States
(12) Patent Application Publication
(10) Pub. No.: US 2024/0354348 A1
(43) Pub. Date: Oct. 24, 2024

(54) SYSTEMS AND METHODS FOR DETECTING EXPOSED ORGANIZATIONAL DATA AND SECRETS TO PREVENT MISUSE

(71) Applicant: Flare Systems Inc., Montreal (CA)

(72) Inventors: Nicholas Antonio Ascoli, Fulton, MD (US); Matthew Mosley, Chantily, VA (US)

(21) Appl. No.: 18/639,929

(22) Filed: Apr. 18, 2024

Related U.S. Application Data
(60) Provisional application No. 63/460,074, filed on Apr. 18, 2023.

(51) Int. Cl. G06F 16/908; G06F 16/955

(52) U.S. Cl. CPC G06F 16/908; G06F 16/955

(57) ABSTRACT

The invention includes systems and methods for detecting exposed secrets using a combination of searches of metadata extracted from publicly exposed files, and searches of the exposed files for pattern matches to identify confidential or sensitive information. Significantly, the subject invention overcomes shortcomings found in the prior art in data leak detection and enables early identification of data leaks so users may take more proactive steps against system infiltration by unauthorized persons engaged in illegal or otherwise troublesome activities.

### CROSS-REFERENCE TO RELATED APPLICATION

This application claims priority to U.S. Provisional Patent Appl. No. 63/460,074, filed Apr. 18, 2023, the entire contents of which are incorporated by reference herein.

### BACKGROUND OF THE INVENTION

### 1. Field of the Invention

The present invention relates generally to information security and, in particular, systems and methods for detecting exposed information such as usernames, passwords, confidential data or other information that can be misused or exploited by attackers.

### 2. Description of the Background

Metadata is “data about data” and can be data about publicly available data. Metadata is ubiquitous across modern data networks and communications platforms, and can be used to find, use and manage data more easily. Metadata can be extracted from publicly exposed files and unfortunately can be used by nefarious actors to find confidential or other sensitive information and use it for illicit purposes.

Present methods require credentials for access to internal systems owned by the end user. Thus, systems can be hacked, or social engineering techniques employed, by unauthorized persons to obtain credentials and cause a data breach. Unfortunately, these activities may not be detected until a breach has occurred and those persons have sensitive data that can be used to commit fraud, hold an enterprise for ransom, sell personal information without authorization or engage in identity theft.

Alternatively, present methods for detecting files leaked from an enterprise may rely on the use of web page indexing techniques to monitor adversary conversations for discussions or posts regarding organizational files. Another present method requires application programming interface (API) access from a security application into the application hosting the files. The security application will scan all files present in the file hosting service for the presence of specific keywords, which limits the utility of such techniques.

Present methods for collecting metadata present in files are not common features of applications which inventory an organization's digital footprint. They are leveraged as techniques by adversaries and offensive security researchers to gain intelligence about the organization using the metadata of the files it has posted. Files may contain the author's internal username, specific versions of software and libraries in use inside the company and provide otherwise valuable context for an attacker's reconnaissance. For this reason, there is a need in the art for a solution for identifying metadata and using it as a pivot for data leak detection while operating completely without internal credentials. These and other objects of the present invention will be understood by one of ordinary skill in the art in view of the disclosure that follows.

### SUMMARY OF THE INVENTION

The invention includes systems and methods for detecting exposed secrets using a combination of searches of metadata extracted from publicly exposed files, and searches of the exposed files for pattern matches to identify confidential or sensitive information. Significantly, the subject invention overcomes shortcomings found in the prior art in data leak detection and enables early identification of data leaks so users may take more proactive steps against system infiltration by unauthorized persons engaged in illegal or otherwise troublesome activities.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which.

FIGS. 1-2 illustrate data processing overviews of the methods enabled by a system according to an exemplary embodiment of the present disclosure.

FIGS. 3-5 illustrate subprocesses useable with the subject invention.

### DETAILED DESCRIPTION OF THE INVENTION

Reference will now be made in detail to preferred embodiments of the present invention, examples of which are illustrated in the accompanying drawings.

The present invention generally comprises systems and methods for detecting exposed secrets for a target organization using a combination of metadata extracted from publicly exposed files, and searches for confidential or sensitive information using extracted metadata to identify possible threats to the target organization. In certain embodiments, the methods described herein are carried out in several steps that leverage cloud provider microservices.

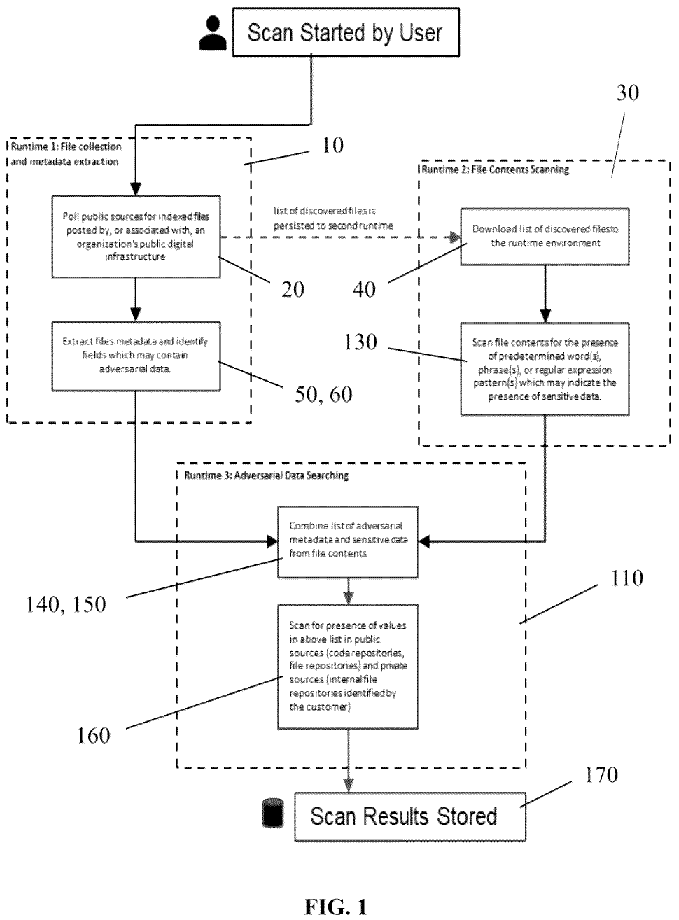

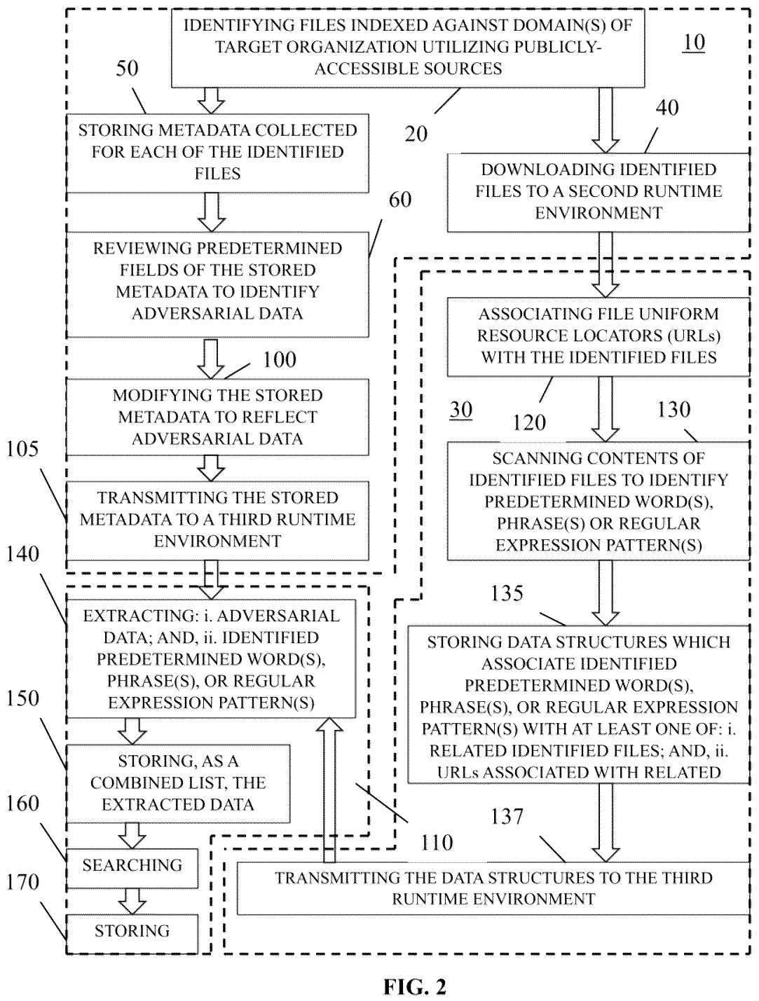

For example, as shown in FIGS. 1-2, a domain may be provided with a first temporary runtime environment as will be understood by one of ordinary skill in the art. The domain is selected as being part of the public-facing digital infrastructure of the target organization. In the first runtime environment, a script will run to probe public sources to identify indexed files associated with the provided domain. The script will download each identified file, and individually collect all metadata attached to each identified file, e.g., using extraction techniques based on exchangeable image file format, or “Exif”. The identified files are downloaded to a second runtime environment for further processing. As will be appreciated by those skilled in the art, multiple domains associated with the target organization may be scanned in parallel and/or in series.

The first runtime environment stores metadata from each of the identified files and reviews predetermined fields of the stored metadata from each file to identify adversarial data, as further discussed below. The stored metadata is modified to reflect the identified adversarial data. The stored metadata is transmitted to a third runtime environment, and the first runtime environment spins itself down.

Within the second runtime environment, the identified files are saved to an external storage location, e.g., each being saved as an organized JavaScript Object Notation (JSON) object. Preferably, the identified files are saved only in text format. Identified non-text files (e.g., .pdf format, PowerPoint format, Excel format) may be transcribed as necessary into text format, (e.g., using optical character recognition (OCR)). In addition, or alternatively, text content may be extracted from the identified files to create related text files which are further processed. Embedded images may likewise be processed to extract text, e.g., utilizing OCR. Identified files may be scrubbed to remove non-text content, e.g., to remove formatting codes, embedded hyperlinks, and other non-text content. Within the JSON object is a uniform resource locator (URL) indicating the location of each identified file on the Internet. A script running in the second temporary runtime environment will scan each identified file to identify the presence of one or more of words, phrases, or regular expression patterns that are predetermined, e.g. in conjunction with the target organization, any such identified terms being considered a “pattern match.” The words, phrases or patterns may be selected to identify terms which indicate a file is confidential, internal, classified, or otherwise proprietary and not for public release. The script will repeat this process for every file listed in the JSON object.

The script will save each appearance of a pattern match, which indicates the file may be sensitive and may have been leaked, into a separate data structure, such as, a JSON object, one for each match, to be associated with the related identified file and/or with the URL of the related identified file. These data structures are then saved using methods known to those of ordinary skill in the art, to be retrieved from a user interface and reviewed by the user. All data structures are transmitted to the third runtime environment, and the second runtime environment spins itself down.

Within the third runtime environment, the identified adversarial metadata is extracted from the stored metadata, and the identified pattern matches are extracted from the data structures. The extracted adversarial metadata and identified pattern matches are merged into a combined list. Knowing the identified adversarial data and identified words, phrases, or patterns of concern are publicly discoverable, the target organization may proactively take steps to limit harm from this leaked information. In addition, the subject invention proactively searches publicly-accessible sources, utilizing the combined list, to identify possible threats to the target organization. This searching may include, but is not limited to, the deep (dark) web to identify possible nefarious activity in connection with the combined list, public code repositories (e.g., GitHub®, GitLab®, Bitbucket®), files made public by collaboration and storage software (e.g., SharePoint®, OneDrive®, Google Drive®), and/or public cloud storage locations (e.g., Microsoft Azure®, AWS S3®, Digital Ocean Spaces®).

The following provides a further discussion of the subject invention. As recognized by those skilled in the art, the subject invention is directed to an online method which may be conducted by one or more computers linked to the Internet. In addition, the subject invention may utilize microservices (e.g., cloud provider microservices), using, for example, the Amazon Web Services® “Lambda” platform and may be entirely serverless.

With reference to FIGS. 1-2, a first runtime environment 10 is schematically shown which may be initiated in any known manner, including with execution of a script. The first runtime environment 10 is intended to work in connection with a specified domain (e.g., as defined by a specified domain name), the domain being associated with a target organization. The target organization is the customer/end user of the subject invention. The subject invention seeks to identify data leaks and possible threats for the target organization. The target organization may be any entity which utilizes the Internet for any purpose (data storage, data sharing, communication, advertising, conducting transactions, and so forth). Utilization of the Internet inherently presents risks both from the perspective of poor internal practices and nefarious actors actively seeking data leaks.

Once initiated, as shown by Step 20, searching is conducted of publicly-accessible sources (e.g., by polling) to identify files indexed against the specified domain. Known techniques may be utilized to conduct the searching. A second runtime environment 30 is initiated, separate from the first runtime environment 10, in which the identified files are downloaded (Step 40). The download of the identified files may be initiated in the first runtime environment 10. Alternatively, a list of the identified files may be transmitted to the second runtime environment 30, with the download of the identified files being initiated in the second runtime environment 30.

In the first runtime environment 10, metadata is collected for each of the identified files. The metadata may be collected by extraction from the identified files. Alternatively, where the metadata is already collected by index sources, the metadata may be collected by retrieving the metadata from the index sources. Once collected, the metadata is stored (Step 50), e.g., as a JSON object. Predetermined fields of the metadata are then reviewed to identify adversarial data (Step 60).

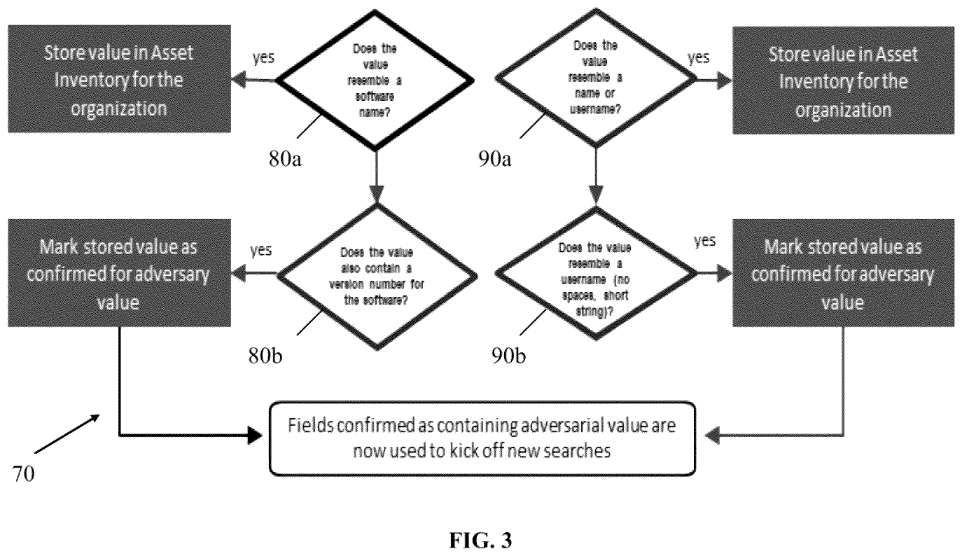

“Adversarial data,” as used herein, refers to data present in predetermined metadata fields of concern, which provide particular vulnerabilities. Predetermined metadata fields of concern herein are metadata fields associated with authors, creators, and producers (these fields may cover one or more of an individual who may have created the file (“author”), software used in creating the file (“creator”), and/or company which produced the software used to create the file (“producer”)). Additional metadata fields of concern may be identified. By way of non-limiting example, the predetermined fields of metadata may be reviewed by running a script in the first runtime environment 10 which searches each file's stored metadata for the presence of a metadata field of concern, such as an ‘author’ field. The identification of the presence of the metadata field of concern alone is not adversarial data. The metadata field of concern must be reviewed for the presence of any entry. An identified entry in a metadata field of concern may be deemed to be adversarial data (i.e., the presence alone suffices to deem the entry to be adversarial date). In addition, or alternatively, it is possible to review the content of the entry to determine whether the entry is deemed to be adversarial data. With reference to FIG. 3, a subprocess 70 is schematically shown in which an entry (referred to as a “value” in FIG. 3) is reviewed under more than one criterion (steps 80a, 80b; 90a, 90b) to be deemed “adversary value” (i.e., adversarial data). FIG. 3 is provided as an example and does not limit the subject invention.

The stored metadata is modified to reflect the presence of adversarial data (Step 100), and the stored (modified) metadata is then transmitted (Step 105) to a third runtime environment 110. The first runtime environment 10 may spin down with completion of the noted steps.

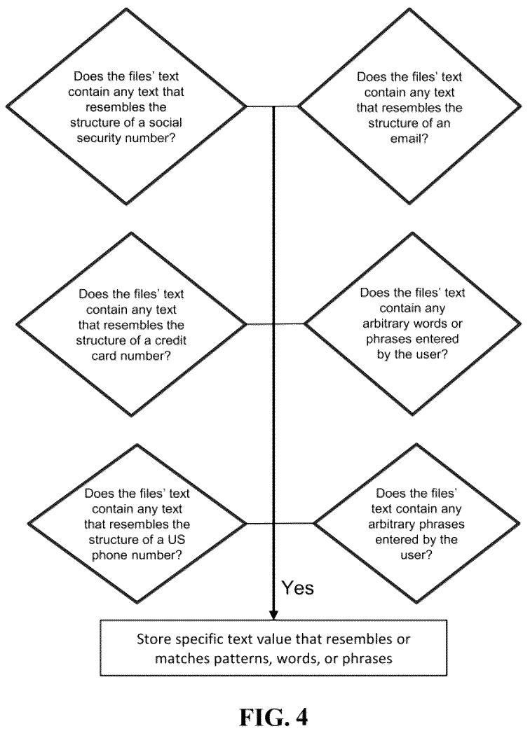

In the second runtime environment 30, uniform resource locators (URLs) are associated with the downloaded identified files (Step 120). The URLs may be extracted from the downloaded identified files or from metadata associated therewith. In addition, the contents of each of the downloaded identified files are scanned to identify the presence of one or more predetermined words, phrases, or regular expression patterns (Step 130) in identifying pattern matches. The words, phrases, or regular expression patterns may be defined by the target organization, particularly as terms of concern unique to their organization (e.g., program names, names of personnel, project names, and the like) and/or generally recognizable terms of concern, such as confidential, proprietary, “not for distribution,” and the like. FIG. 4 provides examples of words, phrases, or regular expression patterns that may be used in connection with Step 130. A script may be initiated to conduct the scans of the contents of each of the files to search for pattern matches.

It is possible to convert non-text files into text form for scanning under Step 130. For example, non-text files, such as those in formats such as .pdf, PowerPoint, Excel, and the like, may be transcribed into text form using any known technique, including, but not limited to, optical character recognition (OCR). In addition, or alternatively, text content may be extracted from the identified files to create related text files which are further processed. Embedded images may likewise be processed to extract text, e.g., utilizing OCR. The files may be also scrubbed to remove formatting codes, hyperlinks, and other non-text codes or features.

Any pattern matches identified under Step 130 may be associated with the related identified files and/or the URLs of the related identified files and stored as data structures (Step 135). The data structures may be JSON objects. The obtained data structures are transmitted to the third runtime environment 110 (Step 137). The second runtime environment 30 may spin itself down with completion of the noted steps.

In the third runtime environment 110, under Step 140, adversarial data is extracted from the stored metadata, and the pattern matches are extracted from the data structures. The extracted data is then stored as a combined list (Step 150). The combined list may be stored in any known format.

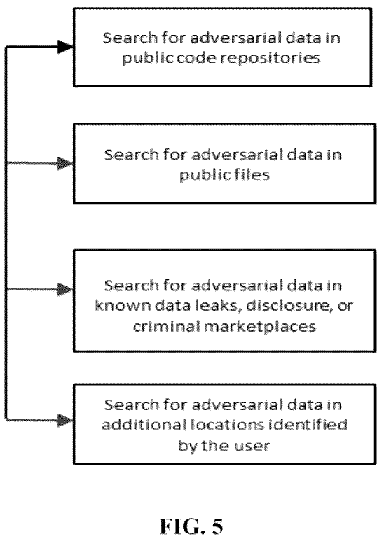

Under Step 160, utilizing the combined list, publicly-accessible sources may be searched to identify possible threats to the target organization. The searches seek to identify hits for any adversarial data or pattern match in a public location, particularly where it should not be located. Searches as shown in FIG. 5 may be conducted, e.g., searching through code available in public code repositories (e.g., GitHub®, GitLab®, Bitbucket®), files made public by collaboration and storage software (e.g., SharePoint®, OneDrive®, Google Drive®), and/or public cloud storage locations (e.g., Microsoft Azure®, AWS S3®, Digital Ocean Spaces®). The presence of internal username, employee phone numbers or other personal information in any of these locations could indicate a leakage of data, theft of data, or misuse of disclosed data.

It is additionally noted that Step 160 may be conducted within internal systems and networks (i.e., non-public digital infrastructure) of the target corporation. The same type of searching may be conducted as described above but in a non-public context.

Any matches resulting from Step 160 will be recorded (Step 170). The locations of any matches may be saved as new data structures, such as new JSON objects, possibly along with other relevant metadata regarding the matches (including metadata about a repository associated with a match). The data structures may be saved to a storage bucket for retrieval by the user interface to be reviewed by the user.

The methods described above may be carried out using known cloud microservices or locally configured runtime environments. For example and not by way of limitation, Amazon Web Services® S3 may be used to provide a storage bucket for retrieval of a JSON object to be retrieved by a user interface to be reviewed by a user; Amazon Web Services® Lambda may be used to set up temporary runtime environments, with the AWS Step function allowing for the arrangement of lambdas in sequence; and AWS Route 53 may be used for displaying the scan results to a user on a web interface.

A system as described in the preceding paragraphs enables data processing methods that lead to optimized threat detection in advance of a potential attack. Metadata retrieval involves a robust subprocess wherein an organizational domain infrastructure and web index sources are scoured for URLs leading to files hosted on the domain infrastructure or third-party infrastructures to which the organization has licensed access. Metadata is extracted from the files, or if already collected by an index source, retrieved from the index source. Metadata fields are then analyzed to identify specific fields which may contain organization-specific conventions for usernames or reveal software running inside the organization. Specific metadata fields may include creator, producer and/or author, which may be processed to determine if field value pairs may contain sensitive information.

When metadata values resembling a software name or username are retrieved, they are stored in an asset inventory database for the organization. When neither of these is the case, the values may be stored in a separate location where adversary value may be confirmed within a system according to the present disclosure. When adversarial value is confirmed, they may be used to inform further search strategies.

Meanwhile, data leak detection according to the present disclosure involves a subprocess wherein the URLs gleaned from metadata retrieval are indexed or files are downloaded locally into a runtime environment as previously described. File content may be transcribed from its original file format into a text file, preserving only the text and removing images, formatting information, etc. The file contents can then be analyzed to identify sensitive field types or arbitrary words or phrases entered by a user.

The text files may be scanned to identify test that resembles a sensitive data structure, such as that of a social security number, an email, or a credit card number, or a phone number, or any arbitrary phrases or words entered by a user. Specific text values that resemble or match patterns, words or phrases may then be used to structure new search strategies in connection with the information gleaned from the metadata retrieval subprocess. Searches for stored data fields may be run in public search repositories, public files, known data leaks, or criminal marketplaces such as the dark web.

It is important to note that while the description above refers to the use of cloud-based microservices to enable the methods described, one of ordinary skill in the art will appreciate that the methods could be recreated using onsite servers, or offsite server infrastructures made available to an enterprise by service contractors which offer such infrastructures. These and other variants and substitutions possible for enabling the appropriate system architecture will be evident to one of ordinary skill in the art.

What is claimed is:

1. An online method for detecting data leaks and possible threats for a target organization, the method comprising:
in a first runtime environment, identifying files indexed against one or more domains associated with the target organization utilizing publicly-accessible sources;
downloading each of the identified files to a second runtime environment;
storing metadata collected for each of the identified files;
reviewing predetermined fields of the stored metadata to identify adversarial data;
modifying the stored metadata to reflect identified adversarial data;
transmitting the stored metadata to a third runtime environment;
in the second runtime environment, associating file uniform resource locaters (URLs) with the identified files;
in the second runtime environment, scanning contents of each of the identified files to identify presence of one or more predetermined words, phrases, or regular expression patterns;
in the second runtime environment, storing data structures which associate the identified predetermined words, phrases, or regular expression patterns with at least one of: i. the identified files in which the predetermined words, phrases, or regular expression patterns were identified;
and, ii. the URLs associated with the identified files in which the predetermined words, phrases, or regular expression patterns were identified;
in the second runtime environment, transmitting the stored data structures to the third runtime environment;
in the third runtime environment, extracting from the stored metadata, the identified adversarial data;
in the third runtime environment, extracting from the stored data structures, the identified predetermined words, phrases, or regular expression patterns;
storing, as a combined list, the extracted identified adversarial data and the extracted identified predetermined words, phrases, or regular expression patterns;
searching publicly-accessible sources utilizing the combined list to identify possible threats to the target organization.

2. The method of claim 1, wherein the metadata is collected by extracting the metadata from the identified files.

3. The method of claim 1, wherein the metadata is collected by retrieving from one or more index sources associated with the identified files.

4. The method of claim 1, wherein the identifying files is initiated by running a script in the first runtime environment.

5. The method of claim 1, wherein the predetermined fields of the collected metadata include one or more of an author field, a creator field, and a producer field.

6. The method of claim 1, further comprising extracting text from any of the identified files which are not in text format.

7. The method of claim 1, further comprising searching private sources utilizing the combined list to identify possible threats to the target organization.

8. A method for detecting data leaks from publicly available information, the method comprising the steps of:
initiating a scan within a metadata runtime environment, wherein the scan comprises the steps of:
scanning files within a public digital infrastructure for information posted by or associated with a target organization;
extracting metadata associated with the files; and
searching for metadata fields with adversarial value;
transmitting the posted information to a data leak runtime routine, wherein file uniform resource locaters (URLs) are collected, files are downloaded, and text pattern matches are identified;
transmitting the extracted metadata, metadata fields and URLs to a repo scanner runtime, wherein identifiers of the target organization are collected from the extracted metadata, metadata fields and URLs; and
storing the results of the scan.
